(19) United States
(12) Patent Application Publication
(10) Pub. No.: US 2024/0287413 A1
(43) Pub. Date: Aug. 29, 2024

(54) LAUNDRY SANITIZING COMPOSITION

(71) Applicant: Reckitt Benckiser Health Limited, Slough, Berkshire (GB)

(72) Inventor: Edward CRUDDEN, Hillside, NJ (US)

(21) Appl. No.: 18/573,628

(22) PCT Filed: Jun. 28, 2022
(86) PCT No.: PCT/GB22/51661

§ 371 Date: Dec. 22, 2023

(30) Foreign Application Priority Data
Jun. 29, 2021 (EP) 21182363.8
Jun. 29, 2021 (GB) 2109330.7

(51) Int. Cl. C11D 3/30; A01N 1/00; A01N 33/12; C11D 1/62; C11D 3/20

(52) U.S. Cl. CPC C11D 3/30; A01N 1/00; A01N 33/12; C11D 1/62; C11D 3/2082; C11D 2111/12

(57) ABSTRACT

Laundry sanitizing composition to provide improved reduction in bacteria during a laundry washing process comprising quaternary ammonium compounds and a C₄₋₈ organic tricarboxylic hydroxy acid. Also, a method for adding a laundry sanitizing composition to a laundry washing process comprising the steps of adding a dose of from about 30 to about 180 ml of a liquid composition to the fabric softener compartment of an automatic washing machine.

The present invention relates to a laundry sanitizing composition to be added to a laundry washing process to provide improved reduction in bacteria during a laundry washing process.

### BACKGROUND

Consumers have increased interest in washing laundry under more energy and water efficient conditions due to environmental concerns. Consumers also have increased interest in laundry compositions with reduced environmental impact, such as less environmentally harmful laundry detergents. Consumers are therefore interested in washing laundry at cooler temperatures, with less water and with milder laundry detergents. Washing laundry under these conditions raises concerns that the resulting items may be visibly clean but may be unhygienic because they may still harbour pathogens. Therefore, there is a growing demand for laundry sanitizing compositions to ensure that clean laundry harbours fewer pathogens. In particular, there is a demand for laundry sanitizing compositions that kill 99.999% of bacteria, which is generally considered “complete kill”.

Dettol® Laundry Cleanser is one available product that is used for sanitizing clean laundry. It contains the non-bleach biocides dialkyl (C₈₋₁₀) dimethylammonium chloride (DDAC) and benzyl-C₁₂₋₁₈-alkyldimethyl chloride (ADBAC). Typically, about 120 ml of Dettol® Laundry Cleanser is added to the fabric softener drawer of the washing machine so that it is used in the washing machine rinse cycle. Dettol® Laundry Cleanser kills 99.9% of bacteria (i.e. a 3-log reduction in bacteria) in laboratory tests.

WO2018108466 and EP3756461A1 disclose a biocidal composition for use in a laundry washing process. The composition comprises one or more water soluble quaternary ammonium compounds and one or more water soluble organic hydroxy acids; wherein the weight ratio of the water soluble organic hydroxy acids to the quaternary ammonium compounds lies in the range from 95:5 to 52:48. Compositions comprising a 1:1:1 mixture of didecyldimethyl ammonium chloride; alkyl dimethyl benzalkonium chloride and alkyl dimethyl ethyl benzalkonium chloride with L-lactic acid or a 1:1 mixture of citric and malonic acid were tested against P. aeruginosa.

WO200100777 relates to hard surface cleaning compositions intended for the removal of oily and greasy soil. The compositions comprise a mixture of disinfecting agent, a booster agent for the disinfecting agent, an anionic surfactant and hydrocarbon ingredient, a water soluble cosurfactant and water. Possible disinfecting agents include C₈-C₁₆ alkyl amines, C₈-C₁₆ alkyl benzyl dimethyl ammonium chlorides, C₈-C₁₆ dialkyl dimethyl ammonium chlorides, C₈-C₁₆ alkyl, C₈-C₁₄ alkyl dimethyl ammonium chloride, dimethyl benzyl alkonium chloride and chlorhexidine and mixtures thereof. Booster agents for the disinfecting agents are selected from the group consisting of a chelant and a hydroxy containing organic acid, such as lactic acid or citric acid, and mixtures thereof. These compositions are intended for direct application to hard surfaces.

WO2016040230 provides disinfectant compositions having at least one biocidal quaternary ammonium compound, hydrogen peroxide, and optionally inorganic acid and/or organic acid. The combination of the quaternary ammonium, the hydrogen peroxide, and the optional acid are suggested to act synergistically.

WO2021156297A1 relates to laundry sanitizing compositions containing a biocide agent and an acidic buffering system, where the biocide agent may include one or more quaternary ammonium compounds.

WO2007142967A2 relates to antimicrobial compositions containing a disinfecting alcohol, a blend containing a C₁₂ to C₂₂ alcohol and an ethoxylated C₁₂ to C₂₂ alcohol, such as a cetearyl alcohol and cetereth-20 blend, a cetearyl alcohol, steareth-20, and steareth-10 blend, or a mixture thereof, an optional organic acid and water.

US 2009/0203570 A1 discloses a fabric conditioner and not a laundry sanitizing composition. The disclosure relates to compositions comprising: 0.1-20% by weight cationic fabric conditioner active; 0.1-5% by weight anion quencher selected from mono-long chain quaternary ammonium compound of the general formula R(R1)3N+X— or alkyl benzyl quaternary ammonium compound of a general formula R2R3(R4)2N+X—; 0.1-10% by weight organic acid having from 1 to 8 carbon atoms; where R is selected from C8-C22 alkyl or alkenyl group, R1 is selected from C1-C3 alkyl group, R2 is selected from C6-C18 alkyl or alkenyl group, R3 is benzyl group, R4 is selected from C1-C3 alkyl group, and X is an anion selected from chloride, bromide, iodide, nitrate, sulfate, methyl sulfate, ethyl sulfate, acetate and phosphate.

U.S. Pat. No. 10,433,545 B2 relates to multi-surface quaternary ammonium disinfectant cleaning compositions that are streak free. The quaternary ammonium disinfecting cleaning compositions comprising a quaternary ammonium compound, an alkyl a polyglycoside with a CMC greater than 1000 ppm and a chelant. Acid may be used in the compositions to adjust the pH of the solution or as divalent metal sequestrants. Example 2 mentions compositions comprising a 1000 ppm quat blend, which is presumed to be 1:1 Bardac 2250:Bardac MB-50, i.e. 1:1 blend of didecyl dimethyl ammonium chloride and ADBAC, and 200 ppm sodium citrate. This gives a ratio of 5:1 quat blend to sodium citrate, alternatively 0.1 wt % quat blend and 0.02 wt % sodium citrate.

There remains a need for laundry sanitizing compositions that kill 99.999% of bacteria, i.e. that provide a 5-log reduction in bacteria, particularly against Pseudomonas aeruginosa, Escherichia coli, Staphylococcus aureus, and Enterococcus hirae in lab testing conditions typically encountered in laundry rinse cycles.

It is an object of the invention to provide a laundry composition with improved reduction in bacteria in conditions typically present during a laundry washing process.

It is also an object of the invention to provide a method of sanitizing laundry during a laundry washing process and which provides improved reduction in bacteria during the laundry washing process.

### STATEMENT OF INVENTION

In a first aspect, the invention provides a laundry composition comprising:
i. at least one cationic biocidal active agent, selected from quaternary ammonium compounds of Formula I:

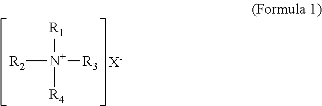

wherein
R₁ and R₂ are independently selected from C₁-C₄ alkyl, C₁-C₄ alkenyl, and C₁-C₄ alkynyl;
R₃ and R₄ are independently selected from C₆-C₂₂ alkyl, C₆-C₂₂ alkenyl, C₆-C₂₂alkynyl;
R₁, R₂, R₃ and R₄ may be straight-chained or may be branched, but are preferably straight-chained, and may include one or more amide, ether or ester linkages and may be optional substituted by a halogen;
X is a salt-forming anion which permits water solubility of the quaternary ammonium complex, for example chloride, bromide or iodide or a methosulfate anion;
ii. at least one cationic biocidal active agent, selected from quaternary ammonium compounds of Formula II:

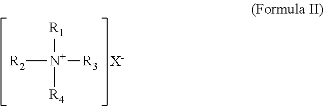

wherein
R₁ and R₂ are independently selected from C₁-C₄ alkyl, C₁-C₄alkenyl, and C₁-C₄alkynyl;
R₃ is selected from C₆-C₂₂ alkyl, C₆-C₂₂ alkenyl, and C₆-C₂₂ alkynyl;
R₁, R₂, and R₃ may be straight-chained or may be branched, but are preferably straight-chained, and may include one or more amide, ether or ester linkages and may be optional substituted by a halogen;
R₄ is a benzyl group, optionally substituted with one or more substituents selected from C₁-C₄ alkyl and halogen;
X is a halide, for example chloride, bromide or iodide, or is a methosulfate anion;
iii. at least one C₄₋₈ organic tricarboxylic acid or a salt thereof.

The at least one cationic biocidal active agent of Formula I may be selected from one or more dialkyldimethyl ammonium chlorides, where each alkyl group is independently selected from straight chain C₈-C₁₀ alkyl.

The at least one cationic biocidal active agent of Formula II may be selected from one or more alkyl dimethyl benzalkonium chlorides (ADBAC also known as BKC):

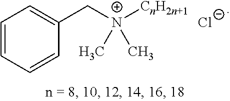

The at least one C₄₋₈ organic tricarboxylic acid, or a salt thereof, may be a C₆ organic tricarboxylic acid or a salt thereof, and is preferably citric acid or a salt thereof.

When a salt of the at least one C₄₋₈ organic tricarboxylic acid is used, the salt-forming cation may be a sodium, potassium, magnesium, calcium, aluminium, ammonium, iron or zinc cation. The salt-forming cation is preferably sodium. More preferably, the salt is sodium citrate, yet more preferably monosodium citrate or trisodium citrate and most preferably the salt is trisodium citrate.

Preferably, the at least one C₄₋₈ organic tricarboxylic acid or the salt thereof is the only organic hydroxy acid species or salt thereof in the composition.

The laundry composition may comprise about 0.5 wt % to about 2.5 wt %, preferably about 1 wt % to about 2 wt %, quaternary ammonium compounds of Formula I. For example, the laundry composition may comprise about 1.44 wt % quaternary ammonium compounds of Formula I.

The laundry composition may comprise about 0.3 wt % to about 1.5 wt %, preferably about 0.7 wt % to about 1.3 wt %, quaternary ammonium compounds of Formula II. For example, the laundry composition may comprise about 0.96 wt % quaternary ammonium compounds of Formula II.

The weight ratio of the quaternary ammonium compounds of Formula I to the quaternary ammonium compounds of Formula II may be in the range 8.33:1 to 1:3 (i.e., 1:0.12 to 3), preferably 2.86:1 to 1:1.3 (i.e., 1:0.35 to 1.3). Most preferably, the weight ratio of the quaternary ammonium compounds of Formula I to the quaternary ammonium compounds of Formula II is about 1.5:1.

The weight ratio of A:B:C, where A is the quaternary ammonium compounds of Formula I; B is the quaternary ammonium compounds of Formula II and C is the at least one C₄₋₈ organic tricarboxylic acid, or a salt thereof, may be in the range 1:0.12 to 3:0.8 to 50 (i.e. A=1, B=0.12 to 3 and C=0.8 to 50), preferably 1:0.35 to 1.3:1.25 to 12.5 (i.e. A=1, B=0.35 to 1.3 and C=1.25 to 12.5). The weight ratio of the quaternary ammonium compounds of Formula I to the quaternary ammonium compounds of Formula II to the at least one C₄₋₈ organic tricarboxylic acid may be about 3:2:13. The weight ratio of the quaternary ammonium compounds of Formula I to the quaternary ammonium compounds of Formula II to the salt of the at least one C₄₋₈ organic tricarboxylic acid may be about 3:2:10.4.

The laundry composition may comprise about 1 wt % to about 25 wt %, such as about 2 wt % to about 25 wt %, preferably about 2.5 wt % to about 12.5 wt %, at least one C₄₋₈ organic tricarboxylic acid, or a salt thereof. For example, the laundry composition may comprise about 6.25 wt % C₄₋₈ organic tricarboxylic acid, or the laundry composition may comprise about 5 wt % of a salt of C₄₋₈ organic tricarboxylic acid.

In one embodiment the laundry composition comprises:
i. about 1.44 wt % of at least one dialkyldimethyl ammonium chloride (DDAC), where each alkyl group is independently selected from straight chain C₈-C₁₀ alkyl;
ii. about 0.96 wt % of one or more alkyl dimethyl benzalkonium chlorides:

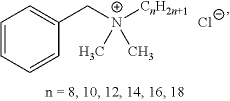

and
iii. about 6.25 wt % citric acid.

In one embodiment the laundry composition comprises:
i. about 1.44 wt % of at least one dialkyldimethyl ammonium chloride (DDAC), where each alkyl group is independently selected from straight chain C₈-C₁₀ alkyl;
ii. about 0.96 wt % of one or more alkyl dimethyl benzalkonium chlorides:

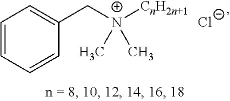

and
iii. about 5 wt % sodium citrate, e.g. trisodium citrate.

In one embodiment the laundry composition consists essentially of:
i. about 1.44 wt % of at least one dialkyldimethyl ammonium chloride (DDAC), where each alkyl group is independently selected from straight chain C₈-C₁₀ alkyl;
ii. about 0.96 wt % of one or more alkyl dimethyl benzalkonium chlorides (BKC):

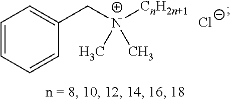

iii. about 2.5 wt % to about 15 wt % citric acid, preferably 6.25% citric acid;
iv. sodium hydroxide, and
v. water.

In one embodiment the laundry composition consists essentially of:
i. about 1.44 wt % of at least one dialkyldimethyl ammonium chloride (DDAC), where each alkyl group is independently selected from straight chain C₈-C₁₀ alkyl;
ii. about 0.96 wt % of one or more alkyl dimethyl benzalkonium chlorides (BKC):

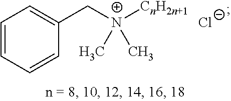

iii. about 1 wt % to about 10 wt % a citric acid salt, preferably about 5 wt % sodium citrate, e.g. trisodium citrate, and
iv. water.

In one embodiment the laundry composition consists of:
vi. about 1.44 wt % of at least one dialkyldimethyl ammonium chloride (DDAC), where each alkyl group is independently selected from straight chain C₈-C₁₀ alkyl;
vii. about 0.96 wt % of one or more alkyl dimethyl benzalkonium chlorides (BKC):

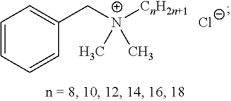

viii. about 2.5 wt % to about 15 wt % citric acid, preferably 6.25% citric acid;
ix. sodium hydroxide;
x. water;
xi. optionally one or more alcohols, such as ethanol, isopropyl alcohol, and ethylene glycol;
xii. optionally a dye;
xiii. optionally a surfactant, such as an alcohol ethoxylate;
xiv. optionally disodium EDTA;
xv. optionally sodium bicarbonate, and
xvi. optionally a fragrance.

In one embodiment the laundry composition consists of:
v. about 1.44 wt % of at least one dialkyldimethyl ammonium chloride (DDAC), where each alkyl group is independently selected from straight chain C₈-C₁₀ alkyl;
vi. about 0.96 wt % of one or more alkyl dimethyl benzalkonium chlorides (BKC):

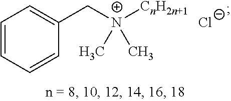

vii. about 1 wt % to about 10 wt % a citric acid salt, preferably about 5 wt % sodium citrate, e.g. trisodium citrate;
viii. water;
ix. optionally one or more alcohols, such as ethanol, isopropyl alcohol, and ethylene glycol;
x. optionally a dye;
xi. optionally a surfactant, such as an alcohol ethoxylate;
xii. optionally disodium EDTA;
xiii. optionally sodium bicarbonate and/or sodium carbonate, and
xiv. optionally a fragrance.

In one embodiment, the laundry composition does not comprise any further quaternary ammonium compounds, such as C₁₂₋₁₄ alkyl dimethyl ethyl benzyl ammonium chlorides (ADEBAC).

The laundry composition of the invention preferably does not contain a bleaching agent, e.g. hydrogen peroxide.

The laundry composition of the invention preferably does not contain an esterquat, e.g. dialkylester ammonium methosulfate.

The laundry composition of the invention preferably does not contain a cationic fabric conditioner active, e.g. di-hydrogenated tallow di-methyl ammonium chloride.

When the laundry composition of the invention uses at least one C₄₋₈ organic tricarboxylic acid, the pH of the solution is less than 7, preferably about 3.

When the laundry composition of the invention uses a salt of the at least one C₄₋₈ organic tricarboxylic acid, the pH of the solution is greater than 7, preferably from about 7 to about 10.

In one embodiment, from about 30 to about 180 ml, preferably about 120 ml, of the laundry composition of the invention at about 1:159 dilution with water achieves at least a 4-log reduction according to the EN1276:2009 protocol, under clean conditions in no more than 22 minutes at 20° C. Preferably, from about 30 to about 180 ml, preferably about 120 ml, of the laundry composition of the invention at about 1:159 dilution with water achieves at least a 5-log reduction according to the EN1276:2009 protocol, under clean conditions in no more than 22 minutes at 20° C.

In a second aspect, the invention provides a method of sanitizing laundry during a laundry washing process comprising adding from about 30 to about 180 ml, preferably about 120 ml, of the laundry composition described herein to the fabric softener compartment of an automatic washing machine and using the automatic washing machine to perform a laundry washing process.

In a third aspect, the invention provides the use of a C₄₋₈ organic tricarboxylic acid, preferably citric acid, or a salt thereof, in a laundry sanitizing composition as described herein in reducing the amount of Escherichia coli, Pseudomonas aeruginosa, Staphylococcus aureus and Enterococcus hirae in a laundry washing process. Preferably, the reduction is a 5-log reduction in no more than 22 minutes at about 20° C. and at about a 1:159 dilution with water, according to the EN1276:2009 suspension test, under clean conditions.

The inventors have surprisingly found that the use of a C₄₋₈ organic tricarboxylic acid or a salt thereof in combination with biocidal quaternary ammonium cations provides improved reduction in bacteria relative to biocidal quaternary ammonium cations alone under conditions representative of a laundry rinse cycle. In particular, the inventors have surprisingly found that citric acid or sodium citrate in combination with didecyldimethylammonium chloride (DDAC) and alkyldimethylbenzylammonium chloride (ADBAC also known as BKC) leads to an improved reduction in bacteria of from about 3-log reduction to about 5-log reduction under conditions representative of a laundry rinse cycle.

### Terms and Definitions

As used herein:
the terms “approximately” and “about” mean plus or minus 10% of the value stated;
the term “a” or “an” means one or more;
any and all ranges are inclusive of their endpoints, e.g. a range of from 1 wt % to 10 wt % w/w includes 1 wt % and 10 wt % and any concentration between 1 wt % and 10 wt %;
all amounts given in % are % by weight (wt %) unless otherwise stated;
the term “benzyl group” is C₆H₅CH₂—.

### EXAMPLES

The following examples illustrate exemplary formulations as well as preferred embodiments of the invention. It is to be understood that these examples are provided by way of illustration only and that further useful formulations falling within the scope of the present invention and the claims may be readily produced by one skilled in the art without deviating from the scope and spirit of the invention.

### Test Method

The compositions in the tables below were evaluated for their antimicrobial efficacy against Staphylococcus aureus (ATCC 6538), Escherichia coli (ATCC 10536), Pseudomonas aeruginosa (ATCC 15442) and Enterococcus hirae (ATCC 10541).

The test method used to evaluate the antimicrobial effectiveness of the Examples was an antimicrobial suspension test based on British Standard reference No: EN 1276:2009 method entitled “Chemical Disinfectants and Antiseptics—Quantitative Suspension Test for the Evaluation of bactericidal activity of chemical disinfectants and antiseptics used in food, industrial, domestic and institutional areas—Test method and requirements (Phase 2, step 1)”. A greater than 5-log reduction of all organisms (Pseudomonas aeruginosa, Staphylococcus aureus, Enterococcus hirae, Escherichia coli) for a contact time of 1 to 60 minutes (determined by product specification) at a testing temperature ranging from 4° C. to 60° C.+1.0° C. (determined by product specification) is required to pass the EN1276. Additional and optional contact times, temperatures, and test organisms can be used.

The test protocol tests the efficacy of the compositions of the present invention and the comparative examples against gram-negative and gram-positive bacteria. The test organisms used were Staphylococcus aureus (ATCC 6538), Escherichia coli (ATCC 10536), Pseudomonas aeruginosa (ATCC 15442) and Enterococcus hirae (ATCC 10541).

The bacterial strains were cultured on tryptic soy agar (TSA) slant from frozen stock and incubated for 18-24 hours. Following incubation, 2^{nd} and 3^{rd} generation transfers were prepared and used to prepare test suspensions as described in the BS EN 1276:2009 test method. The working culture must be either a second or third generation subculture on TSA slants from a cryogenic stock. The cell suspensions were adjusted to produce approximately 1.5-5.0×10⁸ CFU mL⁻¹. Subcultures were prepared on TSA slants and incubated at 36±1° C. for 18-24 hours. The growth medium and temperature used were TSA and 36±1° C. Test solutions and test cultures are equilibrated to a test temperature of 20±1° C. in a water bath.

The tests were performed using “clean” experimental conditions, i.e. 0.3 g/l Bovine Albumin (BA) in-test concentration, rather than “dirty” experimental conditions, i.e. 3 g/l BA in-test concentration. For laundry sanitizers, the desired experimental conditions are “clean conditions” because the laundry sanitizer is used after a laundry detergent in a laundry washing process, i.e. on clean laundry.

Experimentally, a 1:1 dilution of the test culture and test conditions was performed and allowed to react for 2 minutes. 2.0 mL of the test culture was exposed to 8.0 mL of the test product for a 16-minute contact time and then a 1.0 mL aliquot was neutralized in a verified neutralizer. After a 5-minute neutralization time, the neutralized sample was serially diluted, plated on TSA and incubated at 36±1° C. for 48 hours. The average Log₁₀ CFU/mL for the test suspension was calculated and used to compute the log reduction post-treatment. At least a 5-log reduction of all organisms tested for a 16-minute contact time was chosen to indicate that the tested formulation has the desired level of antimicrobial properties against tested organisms. Log reduction greater than 4 means >99.99% reduction in the number of cells; log reduction greater than 5 means >99.999% reduction in the number of cells and denotes complete kill.

The microbiocidal effect (ME) due to the action of the product over the test contact time at the temperature at which the test was performed is expressed by the formula below:

ME=Log Nc−Log Nd

where Nc=Number of cfu/ml of the test suspension count and Nd=Number of cfu/ml of the sample count after treatment.

### Samples

DDAC and BKC are typically provided as solutions containing DDAC or BKC and solvents, which are typically selected from water, ethanol, isopropyl alcohol, ethylene glycol and mixtures thereof. In the following examples the DDAC used was Bardac® 2080, a twin chain dimethyl ammonium chloride composition available from Lonza (CAS No. 68424-95-3), which typically comprises 80% actives (Octyl decyl dimethyl ammonium chloride ˜40%, Dioctyl dimethyl ammonium chloride ˜16% and Didecyl dimethyl ammonium chloride ˜24%), 10% water and 10% ethanol. In the following examples the BKC is BTC 1218-80, (80% BKC) available from Stepan (CAS No. 68424-95-3).

### Sample Preparation

The following formulations were made by adding the raw materials step wise, waiting until the mixture was homogenous after each material was added before adding the next raw material. The raw materials were added in the following order.
1. Deionized water
2. BKC (BTC 1218-80)
3. DDAC (Bardac® 2080)
4. Organic acid(s)
5. Di-sodium EDTA
6. Sodium hydroxide (30%)
7. Deionised water

The sodium hydroxide was added in an amount to adjust the formulation to about pH 3. The final step of deionised water was added in an amount sufficient to achieve the desired amount of active, e.g. 1.8 wt % DDAC and 1.2 wt % BKC.

| | Sample | | | | | |
|---|---|---|---|---|---|---|
| | 1 | 2 | 3 | 4 | 5 | 6 |
| Citric acid (50% | 12 | — | 8.3 | 12.5 | 12.5 | — |
| sol) | | | | | | |
| Lactic acid (50% | — | 12.5 | 4.2 | — | — | 12.5 |
| sol) | | | | | | |
| Succinic Acid | — | — | — | — | — | — |
| Di-Sodium EDTA | — | — | — | — | — | — |
| BKC (80% active) | 3 | 3 | 3 | 1.2 | 3 | 3 |
| DDAC (80% active) | — | — | — | 1.8 | — | — |
| Sodium Hydroxide | 3.2 | 1.716 | 2.484 | 2.796 | 2.656 | 1.74 |
| Sol. (30%) | | | | | | |
| pH | 3.99 | 3 | 3.01 | 3 | 3.03 | 3 |
| S. aureus | >5.18 | 5.23 | >5.23 | >5.23 | >5.23 | 5.26 |
| E. coli | >5.37 | 5.28 | 4.02 | 5.28 | 4.3 | 4.12 |
| P. aeruginosa | 3.76 | 4.3 | 4.23 | 5.39 | 4.72 | 3.22 |
| E. hirae | >5.32 | >5.39 | >5.45 | 5.45 | >5.45 | >5.49 |

| | Sample | | | | |
|---|---|---|---|---|---|
| | 7 | 8 | 9 | 10 | 11 |
| Citric acid (50% sol) | — | — | 6.5 | 12.5 | 12.5 |
| Lactic acid (50% sol) | 8 | 12.5 | — | — | — |
| Succinic Acid | 4.5 | — | — | — | — |
| Di-Sodium EDTA | — | 0.5 | — | 0.5 | — |
| BKC (80% active) | 3 | 1.2 | 1.2 | 1.2 | 1.2 |
| DDAC (80% active) | — | 1.8 | 1.8 | 1.8 | 1.8 |
| Sodium Hydroxide Sol. | 1.688 | 1.98 | 2.0 | 2.0 | 1.73 |
| (30%) | | | | | |
| pH | 3.03 | 3 | 3.07 | 3.03 | 3.03 |
| S. aureus | 5.09 | 5.26 | >5.28 | >5.14 | >5.27 |
| E. coli | 4.44 | 3.92 | >5.37 | >5.27 | >5.31 |
| P. aeruginosa | 2.33 | 5.52 | >5.32 | >5.27 | >5.29 |
| E. hirae | 5.46 | >5.49 | >5.29 | >5.29 | >5.30 |

### Results

Samples 1-3 and 5-7 did not contain DDAC and did not provide a 5-log reduction in P. aeruginosa when tested.

Samples 2 and 6-8 did not contain citric acid and did not provide a 5-log reduction in all four bacteria, typically not against P. aeruginosa. Sample 8 achieved a 5-log reduction in three bacteria but did not achieve a 4-log reduction in E. coli.

All samples containing citric acid, BKC and DDAC achieved a 5-log reduction in all four bacteria, see samples 4 and 9-11. Surprisingly, halving the amount of citric acid still led to a greater than 5-log reduction against all four bacteria, see sample 9 and sample 11.

Tests on samples containing sodium citrate also provided a 5-log reduction in all four bacteria.

The results above demonstrate that the compositions of the present invention show excellent antimicrobial activity against all four bacteria tested.

### Example 2

In the following experiments, all samples were prepared using the method above.

The samples for Experiment 1 used a small amount of non-ionic surfactant to improve stability, so a small amount of non-ionic surfactant was added to all samples in these Experiments. The effect of this small amount of non-ionic surfactant on the germ kill efficacy was considered to be negligible. Samples for Experiment 2 did not require any non-ionic surfactant.

The Samples were tested using the same method above. However, the Samples were tested against Pseudomonas aeruginosa (PSA) only. As shown above, PSA is the most resilient organism, and the Samples were considered highly likely to provide a 5-log reduction against S. aureus, E. coli and E. hirae, particularly if a 5-log reduction was achieved against PSA.

### Experiment 1

| | A | B | C | D | E | F |
|---|---|---|---|---|---|---|
| BKC | 0.8 | 0.96 | 0.84 | 0.96 | 0.84 | 0.84 |
| DDAC | 0.8 | 1.44 | 0.84 | 1.44 | 0.84 | 0.84 |
| ADEBAC | 0.8 | | 0.84 | | 0.84 | 0.84 |
| Malonic Acid | 0.75 | — | — | — | — | — |
| Citric Acid | 0.75 | 6.25 | — | — | — | 3 |
| Lactic Acid | — | — | 3 | 3 | 6.25 | — |
| Total Quat | 2.4 | 2.4 | 2.52 | 2.4 | 2.52 | 2.52 |
| Total Organic Acid | 1.5 | 6.25 | 3 | 3 | 6.25 | 3 |
| PSA Results | <4.10 | >5.47 | 4.23 | 4.38 | >5.47 | >5.47 |

The success criteria in testing were a log reduction above 5 in PSA and so the result for Sample A was given as below 4.1 log reduction, i.e. below the quantification of the test. Sample B, the sample according to the invention, therefore showed an improved antimicrobial activity versus Sample A, which had a Quat: Organic Acid (Q:OA) ratio of 37.5:23.4.

Samples C and D (lactic acid) had a Q:OA ratio of 1:1.19 and 1:1.25, respectively and did not achieve a 5-log reduction in PSA. Sample F, which contained citric acid, showed improved antimicrobial activity over Sample C (equivalent amount of lactic acid).

### Experiment 2

In this experiment, the samples all contained the same quat blend, i.e. 0.96 wt % BKC and 1.44 wt % DDAC (from 1.2 wt % of an 80% active BKC solution and 1.8 wt % of an 80% active DDAC solution) and the amounts of citric acid and malonic acid were varied. As above, the success criteria in testing were a greater-than 5-log reduction in PSA.

| | A | B | C | D | I | E | F | G | H | J |
|---|---|---|---|---|---|---|---|---|---|---|
| Citric Acid | 2.5 | 2 | 1.5 | 1 | 0.5 | 1.5 | 1 | 0.75 | 0.5 | 0.25 |
| Malonic Acid | — | — | — | — | — | 1.5 | 1 | 0.75 | 0.5 | 0.25 |
| PSA Results | >5.31 | >5.31 | >5.31 | >5.31 | 4.6 | >5.31 | >5.31 | >5.31 | 4.96 | 4.24 |

Samples D and H both contained 1% organic acid. Sample D containing citric acid without malonic acid showed improved antimicrobial activity over Sample H containing citric acid and malonic acid.

Sample G demonstrates that the quat combination of the present invention provides improved antimicrobial activity versus the 0.8 wt % BKC, 0.8 wt % DDAC and 0.8 wt % ADEBAC used in Experiment 1, Sample A above.

1. A laundry composition comprising:
i. about 0.5 to about 2.5 wt % of at least one cationic biocidal active agent, selected from quaternary ammonium compounds of Formula I: 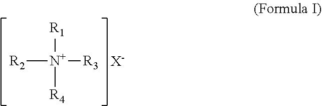
wherein
R₁ and R₂ are independently selected from C₁-C₄ alkyl, C₁-C₄ alkenyl, and C₁-C₄ alkynyl,
R₃ and R₄ are independently selected from C₆-C₂₂ alkyl, C₆-C₂₂ alkenyl, C₆-C₂₂ alkynyl,
R₁, R₂, R₃ and R₄ are straight-chained or branched, optionally include one or more amide, ether, or ester linkages, and optionally are substituted by a halogen;
X is a salt-forming anion which permits water solubility of the quaternary ammonium complex;
ii. about 0.3 to about 1.5 wt % of at least one cationic biocidal active agent, selected from quaternary ammonium compounds of Formula II: 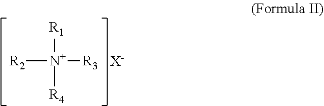
wherein
R₁ and R₂ are independently selected from C₁-C₄ alkyl, C₁-C₄ alkenyl, and C₁-C₄ alkynyl;
R₃ is selected from C₆-C₂₂ alkyl, C₆-C₂₂ alkenyl, C₆-C₂₂ alkynyl;
R₁, R₂, and R₃ are straight-chained or branched, optionally include one or more amide, ether, or ester linkages, and optionally are substituted by a halogen;
R₄ is a benzyl group, optionally substituted with one or more substituents selected from C₁-C₄ alkyl and halogen;
X is a halide or is a methosulfate anion;
iii. about 1 to about 25 wt % of at least one C₄₋₈ organic tricarboxylic acid or a salt thereof.

2. The laundry composition according to claim 1, wherein:
i. the at least one cationic biocidal active agent of Formula I is selected from one or more dialkyldimethyl ammonium chlorides, where each alkyl group is independently selected from straight chain C₈-C₁₀ alkyl; and/or
ii. the at least one cationic biocidal active agent of Formula II is selected from one or more alkyl dimethyl benzalkonium chlorides (BKC): 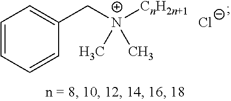
and/or
iii. the at least one C₄₋₈ organic tricarboxylic acid, or a salt thereof, is a C₆ organic tricarboxylic acid or a salt thereof.

3. The laundry composition according to claim 1, wherein the at least one C₄₋₈ organic tricarboxylic acid or a salt thereof is citric acid or a salt thereof; and/or
wherein the at least one C₄₋₈ organic tricarboxylic acid or the salt thereof is the only organic hydroxy acid or salt thereof in the composition.

4. The laundry composition according to claim 1, wherein the salt-forming cation of the at least one C₄₋₈ organic tricarboxylic acid is selected from sodium, potassium, magnesium, calcium, aluminium, ammonium, iron or zinc.

5. The laundry composition according to claim 1, comprising:
about 1 to about 2 wt % quaternary ammonium compounds of Formula I;
about 0.7 to about 1.3 wt % quaternary ammonium compounds of Formula II, and
about 2 to about 25 wt % at least one C₄₋₈ organic tricarboxylic acid, or a salt thereof.

6. The laundry composition of claim 1 comprising:
i. about 1.44 wt % of at least one dialkyldimethyl ammonium chloride (DDAC), where each alkyl group is independently selected from straight chain C₈-C₁₀ alkyl;
ii. about 0.96 wt % of one or more alkyl dimethyl benzalkonium chlorides: 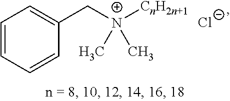
and
iii. about 6.25 wt % citric acid.

7. The laundry composition of claim 1 comprising:
i. about 1.44 wt % of at least one dialkyldimethyl ammonium chloride (DDAC), where each alkyl group is independently selected from straight chain C₈-C₁₀ alkyl;
ii. about 0.96 wt % of one or more alkyl dimethyl benzalkonium chlorides: 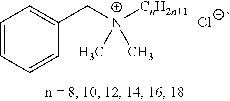
and
iii. about 5 wt % sodium citrate.

8. The laundry composition according to claim 1, wherein the composition does not comprise any further quaternary ammonium compounds.

9. The laundry composition according to claim 1, wherein the composition does not contain a bleach agent.

10. The laundry composition according to claim 1 wherein the at least one C₄₋₈ organic tricarboxylic acid or the salt thereof is the C₄₋₈ organic tricarboxylic acid and the pH of the solution is less than 7.

11. The laundry composition of claim 1, consisting essentially of:
i. about 1.44 wt % of at least one dialkyldimethyl ammonium chloride (DDAC), where each alkyl group is independently selected from straight chain C₈-C₁₀ alkyl;
ii. about 0.96 wt % of one or more alkyl dimethyl benzalkonium chlorides (BKC): 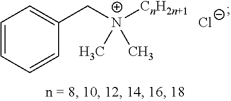
iii. about 2.5 wt % to about 15 wt % citric acid;
iv. sodium hydroxide, and
v. water.

12. The laundry composition of claim 1, consisting essentially of:
i. about 1.44 wt % of at least one dialkyldimethyl ammonium chloride (DDAC), where each alkyl group is independently selected from straight chain C₈-C₁₀ alkyl;
ii. about 0.96 wt % of one or more alkyl dimethyl benzalkonium chlorides (BKC): 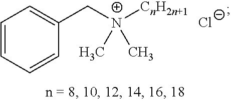
iii. about 1 wt % to about 10 wt % a citric acid salt, and
iv. water.

13. (canceled)

14. A method of sanitizing laundry during a laundry washing process comprising adding from about 30 to about 180 ml of the laundry composition of claim 1 to the fabric softener compartment of an automatic washing machine and using the automatic washing machine to perform a laundry washing process.

15. (canceled)

16. The laundry composition of claim 1, wherein R₁, R₂, R₃, and R₄ of Formula I are straight chained.

17. The laundry composition of claim 1, wherein X of Formula I is a chloride, bromide, iodide, or a methosulfate anion.

18. The laundry composition of claim 1, wherein R₁, R₂, R₃, and R₄ of Formula II are straight chained.

19. The laundry composition of claim 1, wherein X of Formula II is a chloride, bromide, iodide, or a methosulfate anion.

20. The laundry composition of claim 1, wherein the at least one C₄₋₈ organic tricarboxylic acid or the salt thereof is the salt and the pH of the solution is from about 7 to about 10.

21. The laundry composition of claim 1, wherein the at least one C₄₋₈ organic tricarboxylic acid or the salt thereof is the salt and the pH of the solution is greater than 7.

22. The laundry composition of claim 12, wherein the laundry composition consists essentially of about 5 wt % sodium citrate.
